(19) United States
(12) Patent Application Publication
(10) Pub. No.: US 2009/0147042 A1
(43) Pub. Date: Jun. 11, 2009

(54) MICROCAPPING OF INKJET NOZZLES

(75) Inventors: Gregory John McAvoy, Balmain (AU); Emma Rose Kerr, Balmain (AU); Kia Silverbrook, Balmain (AU)

Correspondence Address: SILVERBROOK RESEARCH PTY LTD, 393 DARLING STREET, BALMAIN, 2041, AU

(73) Assignee: SILVERBROOK RESEARCH PTY LTD

(21) Appl. No.: 12/270,854

(22) Filed: Nov. 14, 2008

Related U.S. Application Data
(60) Provisional application No. 60/992,637, filed on Dec. 5, 2007.

(51) Int. Cl. B41J 2/165

(52) U.S. Cl. 347/29

(57) ABSTRACT

An inkjet printer comprising: a printhead comprising a nozzle plate having a plurality of nozzle openings defined therein, said nozzle plate comprising a first relatively hydrophilic layer and a second relatively hydrophobic layer, said second layer defining an ink ejection face for said printhead; and a capper having a planar capping surface, said capper being moveable between a first position in which said capper is disengaged from said printhead and a second position in which said capping surface sealingly engages with said ink ejection face wherein, in said second position, a meniscus of ink contained in each nozzle opening is pinned at an interface between said first and second layers, such that a microwell is defined between said capping surface and said meniscus.

### FIELD OF THE INVENTION

This invention relates to inkjet printhead maintenance. It has been developed primarily for facilitating maintenance operations, such as capping a printhead.

### CO-PENDING APPLICATIONS

The following applications have been filed by the Applicant simultaneously with the present application:

FNE041US FNE043US

The disclosures of these co-pending applications are incorporated herein by reference. The above applications have been identified by their filing docket number, which will be substituted with the corresponding application number, once assigned.

### CROSS REFERENCES TO RELATED APPLICATIONS

Various methods, systems and apparatus relating to the present invention are disclosed in the following U.S. Patents/Patent Applications filed by the applicant or assignee of the present invention:

| | | | | | | |
|---|---|---|---|---|---|---|
| 7344226 | 7328976 | 11/685084 | 11/685086 | 11/685090 | 11/740925 | 11/763444 |
| 11/763443 | 11946840 | 11961712 | 12/017771 | 7367648 | 7370936 | 7401886 |
| 11/246708 | 7401887 | 7384119 | 7401888 | 7387358 | 7413281 | 11/482958 |
| 11/482955 | 11/482962 | 11/482963 | 11/482956 | 11/482954 | 11/482974 | 11/482957 |
| 11/482987 | 11/482959 | 11/482960 | 11/482961 | 11/482964 | 11/482965 | 11/482976 |
| 11/482973 | 11/495815 | 11/495816 | 11/495817 | 60992635 | 60992637 | 60992641 |
| 12050078 | 12050066 | 12138376 | 12138373 | 12142774 | 12140192 | 12140264 |
| 12140270 | 11/607976 | 11/607975 | 11/607999 | 11/607980 | 11/607979 | 11/607978 |
| 11/735961 | 11/685074 | 11/696126 | 11/696144 | 7384131 | 11/763446 | 6665094 |
| 7416280 | 7175774 | 7404625 | 7350903 | 11/293832 | 12142779 | 11/124158 |
| 6238115 | 6390605 | 6322195 | 6612110 | 6480089 | 6460778 | 6305788 |
| 6426014 | 6364453 | 6457795 | 6315399 | 6755509 | 11/763440 | 11/763442 |
| 12114826 | 12114827 | 12239814 | 12239815 | 12239816 | 11/246687 | 7156508 |
| 7303930 | 7246886 | 7128400 | 7108355 | 6987573 | 10/727181 | 6795215 |
| 7407247 | 7374266 | 6924907 | 11/544764 | 11/293804 | 11/293794 | 11/293828 |
| 11/872714 | 10/760254 | 7261400 | 11/583874 | 11/782590 | 11/014764 | 11/014769 |
| 11/293820 | 11/688863 | 12014767 | 12014768 | 12014769 | 12014770 | 12014771 |
| 12014772 | 11/482982 | 11/482983 | 11/482984 | 11/495818 | 11/495819 | 12062514 |
| 12192116 | 7306320 | 10/760180 | 6364451 | 7093494 | 6454482 | 7377635 |

### BACKGROUND OF THE INVENTION

Inkjet printers are commonplace in homes and offices. However, all commercially available inkjet printers suffer from slow print speeds, because the printhead must scan across a stationary sheet of paper. After each sweep of the printhead, the paper advances incrementally until a complete printed page is produced.

It is a goal of inkjet printing to provide a stationary pagewidth printhead, whereby a sheet of paper is fed continuously past the printhead, thereby increasing print speeds greatly. The present Applicant has developed many different types of pagewidth inkjet printheads using MEMS technology, some of which are described in the patents and patent applications listed in the cross reference section above.

The contents of these patents and patent applications are incorporated herein by cross-reference in their entirety.

Notwithstanding the technical challenges of producing a pagewidth inkjet printhead, a crucial aspect of any inkjet printing is maintaining the printhead in an operational printing condition throughout its lifetime. A number of factors may cause an inkjet printhead to become non-operational and it is important for any inkjet printer to include a strategy for preventing printhead failure and/or restoring the printhead to an operational printing condition in the event of failure. Printhead failure may be caused by, for example, printhead face flooding, dried-up nozzles (due to evaporation of water from the nozzles—a phenomenon known in the art as decap), or particulates fouling nozzles.

Accumulation of particulates on the printhead during idle periods should be avoided. Furthermore, particulates, in the form of paper dust, are a particular problem in high-speed pagewidth printing. This is because the paper is typically fed at high speed over a paper guide and past the printhead. Frictional contact of the paper with the paper guide generates large quantities of paper dust compared to traditional scanning inkjet printheads, where paper is fed much more slowly. Hence, pagewidth printheads tend to accumulate paper dust on their ink ejection face during printing. Any accumulation of particulates, either during idle periods or during printing, is highly undesirable.

In the worst case scenario, particulates block nozzles on the printhead, preventing those nozzles from ejecting ink. More usually, paper dust obscures nozzles resulting in misdirected ink droplets during printing. Misdirects are highly undesirable and may result in unacceptably low print quality.

Typically, printheads are capped during idle periods. In some commercial printers, a gasket-type sealing ring and cap engages around a perimeter of the printhead when the printer is idle. FIGS. 1A and 1B show schematically a prior art perimeter capping arrangement for an inkjet printhead. A printhead 1 comprises a plurality of nozzles 3 defined on an ink ejection face 4. A capper 2 comprises a rigid body 5 and a perimeter sealing ring 6. In FIG. 1B, the capper 2 is engaged with the printhead 1 so that the perimeter sealing ring 6 contacts and sealingly engages with the ink ejection face 4. The capper body 5, the sealing ring 6 and the ink ejection face 4 together define a capping chamber 7 when the capper 2 is engaged with the printhead 1. Since the capping chamber 7 is sealed, evaporation of ink from the nozzles 3 is minimized. An advantage of this arrangement is that the capper 2 does not make physical contact with the nozzles, thereby avoiding any damage to the nozzles. A disadvantage of this arrangement is that the capping chamber 7 still holds a relatively large volume of air, meaning that some evaporation of ink into the capping chamber is unavoidable.

Alternatively, FIGS. 2A and 2B show a contact capping arrangement for a printhead, whereby a capper 10 makes contact with the ink ejection face 4. Although this arrangement minimizes the problems of ink evaporation, contact between the capper 10 and the ink ejection face 4 is generally undesirable. In the first place, the ink ejection face is typically defined by a nozzle plate comprised of a hard ceramic material, which may damage a capping surface 11 of the capper 10. In the second place, contact between menisci of ink and the capper 10 results in fouling of the capping surface 11, and measures are usually required to clean the capping surface as well as the printhead.

Although not shown in FIGS. 1A and 1B, a vacuum may be connected to the perimeter capper 2 and used to suck ink from the nozzles 3. The vacuum sucks ink from the nozzles 3 and, in the process, unblocks any nozzles that may have dried out. A disadvantage of vacuum flushing is that it is very wasteful of ink—in many commercial inkjet printers, ink wastage during maintenance is responsible for a significant amount of the overall ink consumption of the printer.

In order to remove flooded ink from a printhead after vacuum flushing, prior art maintenance stations typically employ a rubber squeegee, which is wiped across the printhead. Particulates are removed from the printhead by flotation into the flooded ink and the squeegee removes the flooded ink having particulates dispersed therein.

However, rubber squeegees impart potentially damaging sheer forces across the printhead and require a separate maintenance step after the capper 2 has been disengaged from the printhead 1.

Therefore, it would be desirable to provide an inkjet printhead maintenance station, which does not rely on a rubber squeegee wiping across the printhead to remove flooded ink and particulates.

It would be further desirable to minimize evaporation of ink from the nozzles when the printhead is capped, whilst avoiding potentially damaging contact between the printhead and the capper.

It would be further desirable to avoid the use of a vacuum pump for printhead maintenance.

### SUMMARY OF THE INVENTION

In a first aspect the present invention provides an inkjet printer comprising:
a printhead comprising a nozzle plate having a plurality of nozzle openings defined therein, said nozzle plate comprising a first relatively hydrophilic layer and a second relatively hydrophobic layer, said second layer defining an ink ejection face for said printhead; and
a capper having a planar capping surface, said capper being moveable between a first position in which said capper is disengaged from said printhead and a second position in which said capping surface sealingly engages with said ink ejection face,

wherein, in said second position, a meniscus of ink contained in each nozzle opening is pinned at an interface between said first and second layers, such that a microwell is defined between said capping surface and said meniscus.

Optionally, said microwell has a volume of less than 5000 cubic microns.

Optionally, said microwell has a volume of less than 1000 cubic microns.

Optionally, said second hydrophobic layer is comprised of a polymer.

Optionally, said second hydrophobic layer is comprised of polydimethylsiloxane (PDMS).

Optionally, said second hydrophobic layer has a thickness of between 2 and 30 microns.

Optionally, said second hydrophobic layer has a thickness of between 3 and 15 microns.

Optionally, said first hydrophilic layer is comprised of a ceramic material.

Optionally, said first hydrophilic layer is comprised of a material selected from the group comprising: silicon nitride, silicon oxide and silicon oxynitride.

In another aspect the present invention provides the printer further comprising an engagement mechanism for moving said capper between said first position and said second position.

Optionally, said capping surface is comprised of a hydrophobic material.

Optionally, said capper body is comprised of a resiliently deformable material.

Optionally, said capper is configured such that deformation of said capper body brings said capping surface into sealing engagement with said ink ejection face.

In a second aspect the present invention provides a capping assembly for an inkjet printer, said capping assemblycomprising:
an inkjet printhead comprising a nozzle plate having a plurality of nozzle openings defined therein, said nozzle plate comprising a first relatively hydrophilic layer and a second relatively hydrophobic layer, said second layer defining an ink ejection face for said printhead; and
a capper having a planar capping surface, said capper being moveable between a first position in which said capper is disengaged from said printhead and a second position in which said capping surface sealingly engages with said ink ejection face,

wherein, in said second position, a meniscus of ink contained in each nozzle opening is pinned at an interface between said first and second layers, such that a microwell is defined between said capping surface and said meniscus.

### BRIEF DESCRIPTION OF THE DRAWINGS

Specific forms of the present invention will be now be described in detail, with reference to the following drawings, in which:

FIG. 1A is a schematic transverse section of a prior art printhead maintenance arrangement comprising a printhead and perimeter capper;

FIG. 1B is a schematic transverse section of the printhead maintenance arrangement shown in FIG. 1A with the perimeter capper engaged with the printhead;

FIG. 2A is a schematic transverse section of a prior art printhead maintenance arrangement comprising a printhead and contact capper;

FIG. 2B is a schematic transverse section of the printhead maintenance arrangement shown in FIG. 2A with the contact capper engaged with the printhead;

FIG. 3 is a side section of a nozzle assembly having a hydrophobic coating; FIG. 4 is the nozzle assembly shown in FIG. 3 after capping with a contact capper;

FIG. 5A is a schematic transverse section of a printhead maintenance arrangement comprising a printhead and pressure capper;

FIG. 5B is a schematic transverse section of the printhead maintenance arrangement shown in FIG. 5A at a first stage of engagement; and

FIG. 5C is a schematic transverse section of the printhead maintenance arrangement shown in FIG. 5A at a second stage of engagement.

### DETAILED DESCRIPTION OF SPECIFIC EMBODIMENTS

### Microcapping of Individual Nozzles

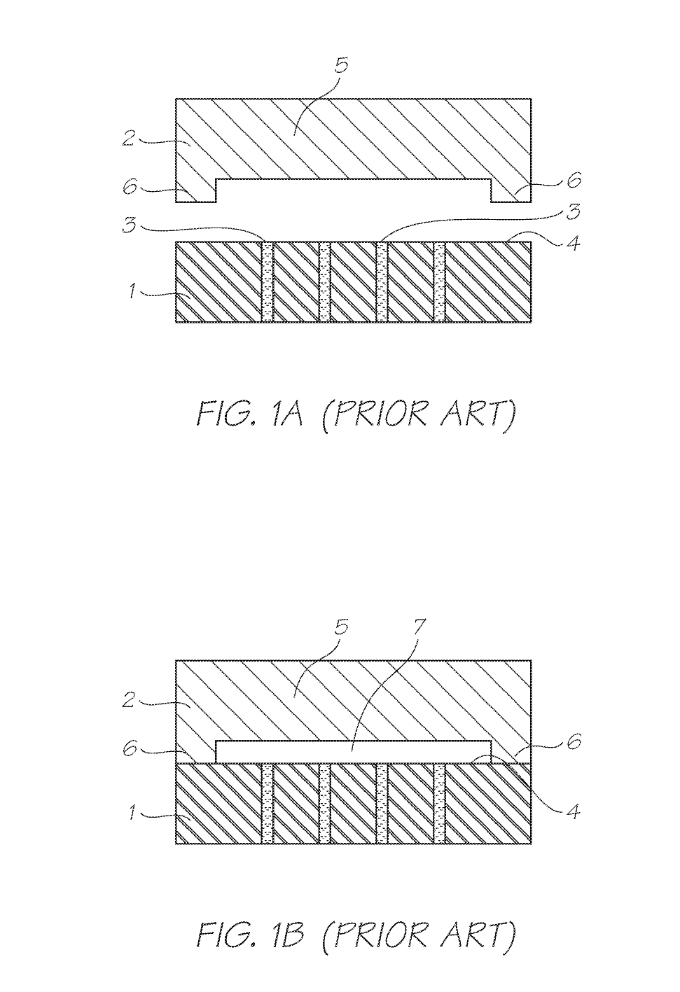

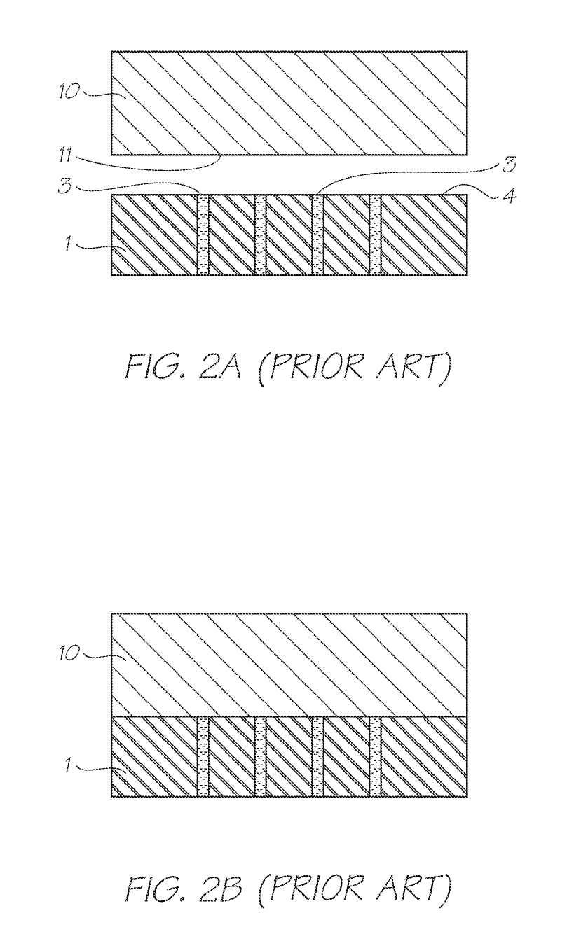

As foreshadowed above, perimeter capping arrangements (FIGS. 1A and 1B) and contact capping arrangements (FIGS. 2A and 2B) have inherent limitations. Notably, perimeter capping arrangements suffer from ink evaporation, and contact capping arrangement suffers from capper fouling due to direct ink contact.

We have previously described the design and fabrication of printheads having a hydrophobic layer of polydimethylsiloxane (PDMS) covering a ceramic nozzle plate. These were described in our earlier U.S. application Ser. No. 11/685,084 filed on Mar. 12, 2007, the contents of which is herein incorporated by reference.

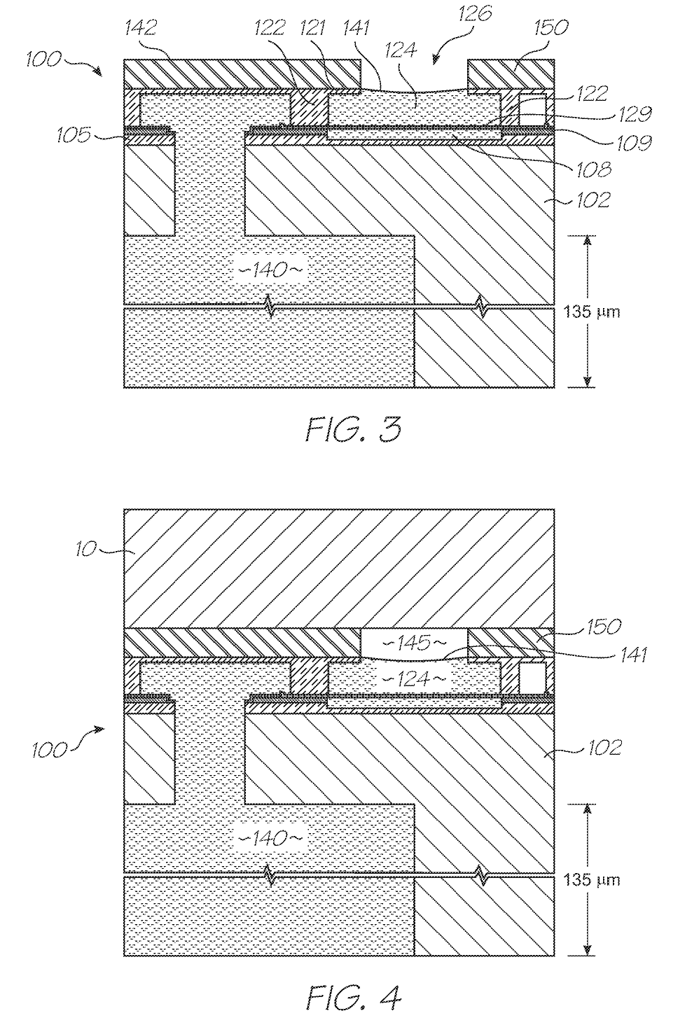

Referring to FIG. 3, there is shown an example of a nozzle assembly 100 having a hydrophobic coating 150. Each nozzle assembly comprises a nozzle chamber 124 formed by MEMS fabrication techniques on a silicon wafer substrate 102. The nozzle chamber 124 is defined by a roof 121 and sidewalls 122 which extend from the roof 121 to the silicon substrate 102. A nozzle aperture 126 is defined in a roof of each nozzle chamber 24. The actuator for ejecting ink from the nozzle chamber 124 is a heater element 129 positioned beneath the nozzle opening 126 and suspended across a pit 108. Current is supplied to the heater element 129 via electrodes 109 connected to drive circuitry in underlying CMOS layers 105 of the substrate 102. When a current is passed through the heater element 129, it rapidly superheats surrounding ink to form a gas bubble, which forces ink through the nozzle aperture 126. By suspending the heater element 129, it is completely immersed in ink when the nozzle chamber 124 is primed. This improves printhead efficiency, because less heat dissipates into the underlying substrate 102 and more input energy is used to generate a bubble.

The roof 121 and sidewalls 122 are formed of a ceramic material (e.g. silicon nitride), which is deposited by PECVD over a sacrificial scaffold of photoresist during MEMS fabrication. These hard materials have excellent properties for printhead robustness, and their inherently hydrophilic nature is advantageous for supplying ink 140 to the nozzle chamber 124 by capillary action. The roof 121 defines part of a first hydrophilic layer of a nozzle plate, which spans across an array of nozzle assemblies on the printhead.

The hydrophilic layer of the nozzle plate is coated with a hydrophobic PDMS layer 150, which primarily assists in minimizing printhead face flooding. A hydrophobic/hydrophilic interface is defined where the PDMS layer 150 meets the roof 121. When the printhead is primed, as shown in FIG. 3, ink contained in the nozzle chamber 124 has a meniscus 141 pinned across the nozzle aperture 126 at this hydrophilic/hydrophobic interface. Hence, the meniscus 140 of ink is pinned below the ink ejection face 142 of the printhead, which is defined by the PDMS layer 150. It will be appreciated that by increasing the height of the PDMS layer 150, the meniscus 141 is pinned deeper below the ink ejection face 142, because the meniscus is always pinned across the hydrophobic/hydrophilic interface.

Turning now to FIG. 4, there is shown an individual nozzle assembly 100, which has been capped by a contact capper 10, as described above in connection with FIGS. 2A and 2B. Due to the height of the PDMS layer 150, a microwell 145 is formed above the meniscus 141 when the printhead is in the capped state. This microwell 145 minimizes direct contact between the capper 10 and the ink 140, and hence minimizes fouling of the capper. Increasing the height of the PDMS layer 150 further minimizes the risk of capper fouling. Typically, the hydrophobic layer 150 has a thickness of between 2 and 30 microns, optionally between 3 and 15 microns.

The volume of air contained in the microwell 145 is relatively small, typically less than about 10,000 cubic microns, less than about 5000 cubic microns, less than about 1000 cubic microns or less than about 500 cubic microns. Since the volume of air contained in each microwell 145 is small, it can quickly become saturated with water vapour from the ink. Once the microwell 145 is saturated with water vapour and sealed from the atmosphere, the risk of nozzles drying out is minimized.

Optimal capping and sealing is achieved when the capper 10 has a capping surface 11 comprised of a hydrophobic material. Examples of suitable hydrophobic materials are siloxanes (e.g. PDMS), silicones, polyolefins (e.g. polyethylene, polypropylene, perfluorinated polyethylene), polyurethanes, Neoprene®, Santoprene®, Kraton® etc.

Accordingly, the present invention achieves microcapping of individual nozzles by virtue of the hydrophobic layer 150 combined with the contact capper 10. Microcapping in this way minimizes the risk of nozzles drying out when left for long periods in their capped state. A further advantage of the present invention is that the capper 10 does not require high alignment accuracy with respect to the printhead. These and other advantages will be readily apparent to the person skilled in the art.

### Pressure Capping

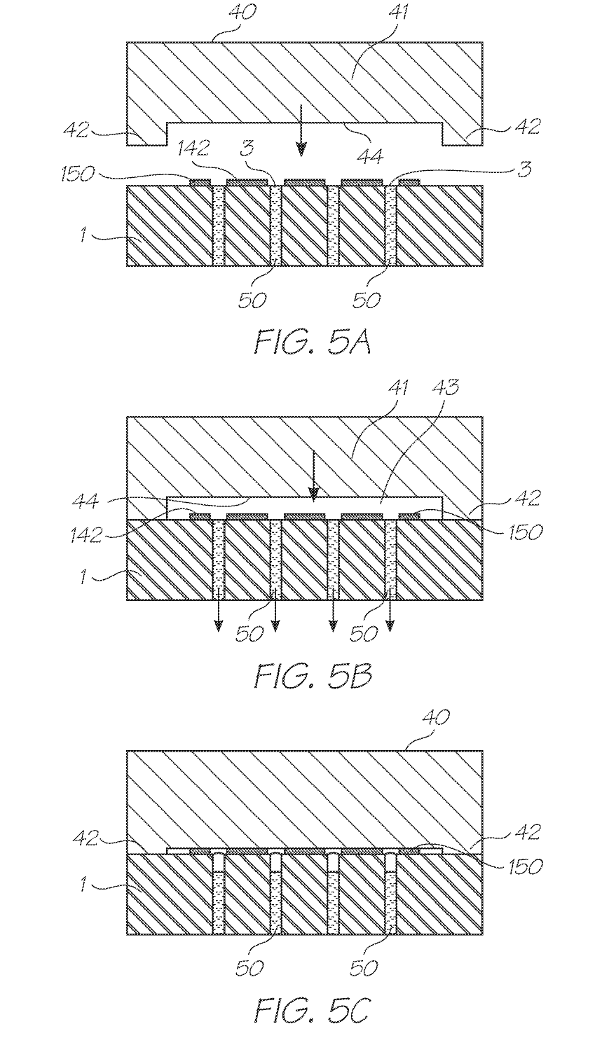

The embodiment described above in connection with FIGS. 3 and 4 may be further enhanced by the use of ‘pressure capping’. FIGS. 5A to 5C illustrate the concept of pressure capping the printhead 1 having a hydrophobic layer 150.

A pressure capper 40 comprises a capper body 41 formed from a flexible, resilient material and a perimeter seal 42 extending from the capper body. As shown in FIG. 5B, in a first stage of capping, the pressure capper 40 caps the printhead 1 similarly to the perimeter capper 2 shown in FIG. 1B. In other words, the perimeter seal 42 sealingly engages with the printhead 1 so as to define an air cavity 43 between the nozzles 3 and the capper body 41.

However, in second stage of capping, and referring now to FIG. 5C, further pressure on the capper 40 deforms the body 41, and forces a capping surface 44 of the body into engagement with the hydrophobic ink ejection face 142 of the printhead 1. During this engagement, the compliant capper body 41 contacts the hydrophobic ink ejection face 142 and seals the nozzles 3. Furthermore, since the perimeter seal 42 forms an airtight seal with the printhead 1, trapped air inside the cavity 43 is forced into the nozzles 3, which, in turn, forces ink to retreat into ink supply channels 50 in the printhead 1.

By forcing ink to retreat back into the supply channels 50 during capping, it is ensured that no ink comes into contact with the capper 40, and the capping surface 44 remains clean. Moreover, the seal between the capping surface 44 and the hydrophobic ink ejection face 142, together with the relatively small volume of air trapped inside each nozzle, minimize the risk of nozzles drying out when capped.

The capper body 41 may be formed of any suitable compliant material. The present invention is particularly efficacious when the capper body 41 and/or the ink ejection face 142 are both relatively hydrophobic. Accordingly, the capper body 41 may be comprised of materials such as siloxanes (e.g. PDMS), silicones, polyolefins (e.g. polyethylene, polypropylene, perfluorinated polyethylene), polyurethanes, Neoprene®, Santoprene®, Kraton® etc.

Although not shown in FIG. 5, any suitable mechanism may be used to engage and disengage the capper 40 from the printhead 1. The capping mechanism should be preferably configured to provide a first disengaged position (FIG. 5A), a second perimeter-capping engagement position (FIG. 5B) a third contact-capping engagement position (FIG. 5C). For example, in our earlier US Publication No. 2007/126784, the contents of which is herein incorporated by reference, we described a mechanism for linearly bringing a cleaning belt into engagement with a printhead. The skilled person will appreciate that such a mechanism may be readily modified for use with the integrated capper/cleaner arrangement of the present invention.

It will, of course, be appreciated that the present invention has been described purely by way of example and that modifications of detail may be made within the scope of the invention, which is defined by the accompanying claims.

1. An inkjet printer comprising:
a printhead comprising a nozzle plate having a plurality of nozzle openings defined therein, said nozzle plate comprising a first relatively hydrophilic layer and a second relatively hydrophobic layer, said second layer defining an ink ejection face for said printhead; and
a capper having a planar capping surface, said capper being moveable between a first position in which said capper is disengaged from said printhead and a second position in which said capping surface sealingly engages with said ink ejection face,
wherein, in said second position, a meniscus of ink contained in each nozzle opening is pinned at an interface between said first and second layers, such that a microwell is defined between said capping surface and said meniscus.

2. The printer of claim 1, wherein said microwell has a volume of less than 5000 cubic microns.

3. The printer of claim 1, wherein said microwell has a volume of less than 1000 cubic microns.

4. The printer of claim 1, wherein said second hydrophobic layer is comprised of a polymer.

5. The printer of claim 4, wherein said second hydrophobic layer is comprised of polydimethylsiloxane (PDMS).

6. The printer of claim 1, wherein said second hydrophobic layer has a thickness of between 2 and 30 microns.

7. The printer of claim 1, wherein said second hydrophobic layer has a thickness of between 3 and 15 microns.

8. The printer of claim 1, wherein said first hydrophilic layer is comprised of a ceramic material.

9. The printer of claim 1, wherein said first hydrophilic layer is comprised of a material selected from the group comprising: silicon nitride, silicon oxide and silicon oxynitride.

10. The printer of claim 1, further comprising an engagement mechanism for moving said capper between said first position and said second position.

11. The printer of claim 1, wherein said capping surface is comprised of a hydrophobic material.

12. The printer of claim 1, wherein said capper body is comprised of a resiliently deformable material.

13. The printer of claim 12, wherein said capper is configured such that deformation of said capper body brings said capping surface into sealing engagement with said ink ejection face.

14. A capping assembly for an inkjet printer, said capping assemblycomprising:
an inkjet printhead comprising a nozzle plate having a plurality of nozzle openings defined therein, said nozzle plate comprising a first relatively hydrophilic layer and a second relatively hydrophobic layer, said second layer defining an ink ejection face for said printhead; and
a capper having a planar capping surface, said capper being moveable between a first position in which said capper is disengaged from said printhead and a second position in which said capping surface sealingly engages with said ink ejection face,
wherein, in said second position, a meniscus of ink contained in each nozzle opening is pinned at an interface between said first and second layers, such that a microwell is defined between said capping surface and said meniscus.
